(19) United States
(12) Patent Application Publication
(10) Pub. No.: US 2018/0143577 A1
(43) Pub. Date: May 24, 2018

(54) IMAGE FORMING SYSTEM, METHOD OF CONTROLLING IMAGE FORMING SYSTEM, AND POST-PROCESSING APPARATUS

(71) Applicants: KABUSHIKI KAISHA TOSHIBA, Tokyo (JP); TOSHIBA TEC KABUSHIKI KAISHA, Tokyo (JP)

(72) Inventor: Mitsunori ISHII, Ota Tokyo (JP)

(21) Appl. No.: 15/356,080

(22) Filed: Nov. 18, 2016

(51) Int. Cl. G03G 15/00

(52) U.S. Cl. CPC G03G 15/6541

(57) ABSTRACT

An image forming system according to an embodiment includes an image forming unit that forms an image on each of a plurality of recording media. A binding unit binds at least two of the recording media together at a binding position thereof to form a bundle. A discharge tray is configured to hold bundles formed by the binding unit. A control unit controls the binding unit and the image forming unit so that a first bundle and a subsequent second bundle are stacked on the discharge tray with the respective binding positions thereof in a first direction parallel to a transport direction of the recording media and a second direction perpendicular to the transport direction of the recording media.

### FIELD

Embodiments described herein relate generally to an image forming system and a method of controlling the image forming system.

### BACKGROUND

There is an image forming system provided with an image forming unit and a stapling unit. The image forming unit forms an image on a sheet. The stapling unit staples multiple sheets together. The image forming system discharges the stapled sheets to a discharge tray. However, when multiple stapled sheet bundles are discharged to the discharge tray and stacked, portions having the staples may accumulate higher than portions not having the staples so that the stack of bundles is not flat. Therefore, the stacked sheets may collapse.

### DESCRIPTION OF THE DRAWINGS

FIG. 1 is a schematic diagram illustrating an example configuration of an image forming system according an embodiment.

FIG. 2 is a schematic block diagram illustrating an example configuration of functional blocks of the image forming system.

FIG. 3 is a diagram illustrating a binding unit of the image forming system.

FIG. 4 is a diagram illustrating an example of an offset unit.

FIG. 5 is a flowchart illustrating an example sequence of operations for controlling the image forming system of the embodiment.

FIG. 6 is a front view illustrating a stacking state of sheet bundles when a normal printing operation is performed.

FIG. 7 is a side view illustrating the stacking state of the sheet bundles when the normal printing operation is performed.

FIG. 8 is a front view illustrating a stacking state of sheet bundles when a stacking state priority operation is performed.

FIG. 9 is a side view illustrating the stacking state of the sheet bundles when the stacking state priority operation is performed.

FIG. 10 is a front view illustrating a stacking state of sheet bundles when an offset discharge operation is performed.

FIG. 11 is a plan view of a front-surface oriented sheet bundle.

FIG. 12 is a plan view of a rear-surface oriented sheet bundle.

FIG. 13 is a diagram illustrating a distribution state of the sheet bundles when a front and rear alternating printing operation is performed.

FIG. 14 is a front view illustrating a stacking state of sheet bundles when the front and rear alternating printing operation is performed.

FIG. 15 is a plan view of a vertically oriented printing sheet bundle.

FIG. 16 is a plan view of a horizontally oriented printing sheet bundle.

FIG. 17 is a diagram illustrating a distribution state of the sheet bundles when the vertical and horizontal alternating printing operation is performed.

FIG. 18 is a front view illustrating a stacking state of the sheet bundles when the vertical and horizontal alternating printing operation is performed.

FIG. 19 is a front view illustrating a stacking state of the sheet bundles when the vertical and horizontal alternating printing and the offset discharge operations are performed in combination.

### DETAILED DESCRIPTION

An image forming system according to an embodiment includes an image forming unit that forms an image on each of a plurality of recording media. A binding unit binds at least two of the recording media together at a binding position thereof to form a bundle. A discharge tray is configured to hold bundles formed by the binding unit. A control unit controls the binding unit and the image forming unit so that a first bundle and a subsequent second bundle are stacked on the discharge tray with the respective binding positions thereof in a first direction parallel to a transport direction of the recording media and a second direction perpendicular to the transport direction of the recording media.

Hereinafter, the image forming system of the embodiment will be described with reference to the drawings. In the drawings, the same configurations will be denoted by the same reference numerals.

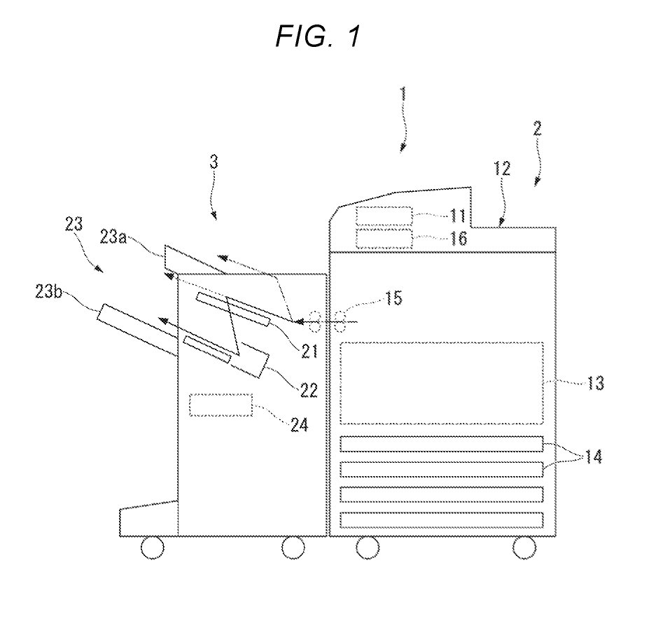

FIG. 1 is a schematic diagram illustrating an example configuration of an image forming system 1 of the embodiment.

As illustrated in FIG. 1, the image forming system 1 includes an image forming apparatus 2 and a post-processing apparatus 3.

First, the image forming apparatus 2 will be described. The image forming apparatus 2 forms an image on a recording medium (hereinafter, referred to as “sheet”) such as paper. For example, the image forming apparatus 2 is a multi-function peripheral (MFP). The image forming apparatus 2 includes a control panel 11, a scanner unit 12, a printer unit 13 (image forming unit), a paper feeding unit 14 (supply unit), a paper discharge unit 15, and an image forming control unit 16 (control unit).

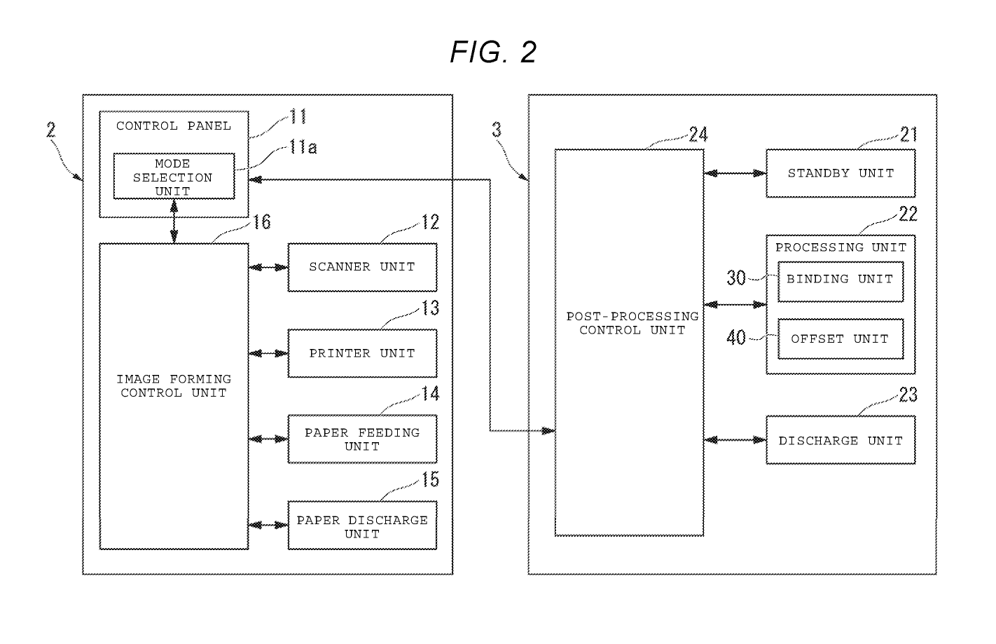

The control panel 11 includes various keys adapted to receive an operation of a user. The control panel 11 is configured to provide a mode selection unit 11a (see FIG. 2) that allows a user to select various modes. For example, the control panel 11 receives an input selecting a type of post-processing of the sheet. For example, the control panel 11 receives the selection of a sort mode, a staple mode, or a non-sort mode. Here, the “sort mode” means a mode in which sorting is performed. The “staple mode” means a mode in which stapling is performed. The “non-sort mode” means a mode in which neither sorting and stapling is performed. When the non-sort mode is selected, the control panel 11 provides the user with a selection of whether to discharge a sheet S to a discharge tray 23a or a discharge tray 23b. The control panel 11 sends information about the selected type of post-processing to the post-processing apparatus 3.

The scanner unit 12 reads a scanning object and generates image data corresponding to the scanning object. The scanner unit 12 sends the image data to the printer unit 13.

The printer unit 13 forms an image (hereinafter, referred to as “toner image”) with a developer such as a toner based on the image data sent from the scanner unit 12 or from an external device. The printer unit 13 transfers the toner image onto a surface of a sheet. The printer unit 13 fixes the toner image to the sheet by applying a pressure and heat to the toner image transferred onto the sheet.

The paper feeding unit 14 supplies sheets to the printer unit 13 one by one. The paper feeding unit 14 may include a first medium storage unit and a second medium storage unit.

The paper discharge unit 15 transports the sheet discharged from the printer unit 13 to the post-processing apparatus 3.

FIG. 2 is a schematic block diagram illustrating an example of a configuration of functional blocks of the image forming system 1.

As illustrated in FIG. 2, the image forming control unit 16 controls the all operations of the image forming apparatus 2. That is, the image forming control unit 16 controls the control panel 11, the scanner unit 12, the printer unit 13, the paper feeding unit 14, and the paper discharge unit 15. The image forming control unit 16 includes a control circuit including a CPU, a ROM, and a RAM.

Next, the post-processing apparatus 3 will be described. As illustrated in FIG. 1, the post-processing apparatus 3 is adjacent to the image forming apparatus 2. The post-processing apparatus 3 executes the post-processing specified through the control panel 11 on a sheet transported from the image forming apparatus 2. For example, the post-processing may be stapling or sorting. The post-processing apparatus 3 includes a standby unit 21, a processing unit 22, a discharge unit 23, and a post-processing control unit 24.

The standby unit 21 allows a sheet transported from the image forming apparatus 2 to be temporarily held therein. For example, the standby unit 21 may hold one or more subsequent sheets to stand-by during the post-processing of sheets already in the processing unit 22. The standby unit 21 is provided above the processing unit 22. When the processing unit 22 is empty, the standby unit 21 drops the staying sheets toward the processing unit 22.

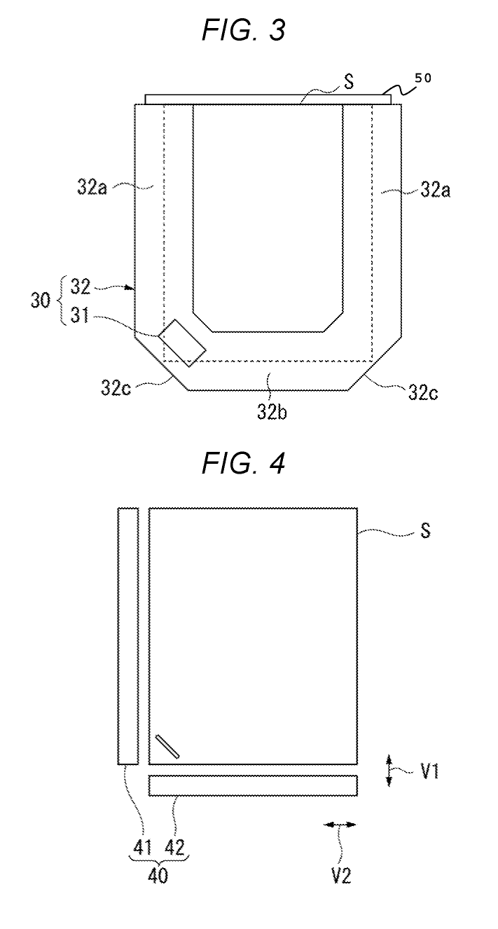

The processing unit 22 subjects sheets to post-processing. For example, the processing unit 22 aligns a plurality of sheets. The processing unit 22 includes the binding unit 30 (see FIG. 3), an offset unit 40 (see FIG. 4), and a stacking unit 50 (see FIG. 3). The stacking unit 50 receives and stacks a sheet transported from the image forming apparatus.

FIG. 3 is a diagram illustrating an example of the binding unit 30 of the embodiment.

As illustrated in FIG. 3, the binding unit 30 includes a stapler 31 and a guide rail 32. The stapler 31 binds a plurality of sheets S together with a needle. When viewed from the top, the guide rail 32 forms a U-shape along three sides of a rectangular sheet S. The guide rail 32 includes first rail portions 32a, a second rail portion 32b, and third rail portions 32c. When viewed from the top, the first rail portions 32a linearly extend along long sides of a sheet S. When viewed from the top, the second rail portion 32b linearly extends along a short side of a sheet S. When viewed from the top, the third rail portions 32c extend in directions intersecting and inclined relative to the first rail unit 32a and the second rail unit 32b. The stapler 31 is movable along the guide rail 32 by a driving unit (not shown). The stapler 31 can bind sheets S at an arbitrary position on the guide rail 32.

By virtue of the configuration, the binding unit 30 staples a plurality of aligned sheets S together. Accordingly, the plurality of sheets S are bound together, and thus a sheet bundle is obtained.

FIG. 4 is a diagram illustrating an example of the offset unit 40 of the embodiment.

As illustrated in FIG. 4, the offset unit 40 includes a first slider 41 and a second slider 42.

Hereinafter, a direction parallel to a transport direction of a sheet S will be referred to as a first direction (arrow V1 in the drawings). In addition, a direction intersecting the transport direction of a sheet S will be referred to as a second direction (arrow V2 in the drawings). In the embodiment, the “transport direction of a sheet S” means a transport direction of a sheet S (including a sheet bundle) with respect to the discharge tray 23a or 23b. In the embodiment, the second direction is a direction perpendicular to the transport direction of a sheet S. In FIG. 4, the first direction V1 coincides with a long edge of a sheet S, and the second direction V2 coincides with a short edge of a sheet S.

When viewed from the top, the first slider 41 extends in the first direction V1. The first slider 41 is movable in the second direction V2 by a driving unit (not shown). When viewed from the top, the second slider 42 extends in the second direction V2. The second slider 42 is movable in the first direction V1 by a driving unit (not shown).

By virtue of the configuration, the offset unit 40 shifts sheet bundles in the first direction V1 or the second direction V2. Accordingly, the sheet bundles shifted in the first direction V1 or the second direction V2 are discharged to the discharge tray 23a or 23b.

As illustrated in FIG. 1, the processing unit 22 discharges the sheet S subjected to the post-processing to the discharge unit 23.

The discharge unit 23 includes the discharge trays 23a and 23b to which sheets S are discharged. The discharge trays 23a and 23b receives sheets or sheet bundles. The discharge tray 23a is provided in an upper part of the post-processing apparatus 3. For example, the discharge tray 23a may be a fixed tray. The discharge tray 23b is provided in a side portion of the post-processing apparatus 3. For example, the discharge tray 23b may be a movable tray.

As illustrated in FIG. 2, the post-processing control unit 24 controls the overall operation of the post-processing apparatus 3. That is, the post-processing control unit 24 controls the standby unit 21, the processing unit 22, and the discharge unit 23. The post-processing control unit 24 includes a control circuit including a CPU, a ROM, and a RAM.

Hereinafter, the image forming control unit 16 and the post-processing control unit 24 will be collectively called “control unit”. The control unit controls the printer unit 13 and the binding unit 30 such that binding positions related to a first sheet S (first recording medium) and a subsequent second sheet S (second recording medium) are distributed in the first direction V1 or the second direction V2. Here, the first sheet S means an arbitrary sheet which is discharged to the discharge unit 23. The second sheet S means a sheet which is different from the first sheet S and which is discharged to the discharge unit 23 after the first sheet S. That is, the control unit controls the distribution of the binding positions by making the image forming apparatus 2 and the post-processing apparatus 3 cooperate. The control unit controls at least one of the printer unit 13, the paper feeding unit 14, the binding unit 30, and the offset unit 40 according to a stack mode or a print mode.

A stacked sheet number priority mode (first mode) and a stacking state priority mode (second mode) can be selected through the mode selection unit 11a. Here, the “stacked sheet number priority mode” means a mode in which binding positions related to a first sheet S and a second sheet S are distributed in the first direction V1 or the second direction V2. That is, the “stacked sheet number priority mode” is a mode in which collapse of sheets S stacked in the discharge tray 23a or 23b is suppressed to put priority on increasing the number of sheets S stacked. The “stacking state priority mode” means a mode in which binding positions related to a first sheet S and a second sheet S are in a fixed position without being distributed in the first direction V1 or the second direction V2. That is, the “stacking state priority mode” is a mode in which priority is put on improving the stacking state of sheets S while the possibility of collapse of the stacked sheets S is left.

Next, an example of the control of the control unit in the stacked sheet number priority mode will be described.

For example, the control unit controls the printer unit 13 such that front-surface printing and rear-surface printing are alternately performed. In addition, the control unit controls the binding unit 30 such that binding positions related to sheets S subjected to front-surface printing and binding positions related to sheets S subjected to rear-surface printing are distributed in the first direction V1 or the second direction V2. Here, the “front-surface printing” means forming an image on a first surface (front surface) of a sheet S. The “rear-surface printing” means forming an image on a second surface (rear surface) on an opposite side to the first surface of the sheet S.

The paper feeding unit 14 supplies vertically oriented sheets and horizontally oriented sheets. Here, the “vertically oriented sheet” means a sheet S having the longer edge in the first direction V1. The “horizontally oriented sheet” means a sheet S having the shorter edge in the first direction V1 (that is, having the longer edge in the second direction V2).

For example, the control unit controls the paper feeding unit 14 such that vertically oriented sheets and horizontally oriented sheets are alternately supplied. In addition, the control unit controls the binding unit 30 such that binding positions related to vertically oriented sheets and binding positions related to horizontally oriented sheets are distributed in the first direction V1 or the second direction V2.

For example, the control unit controls the offset unit 40 to shift a sheet S which is discharged to the discharge tray 23a or 23b in the first direction V1 or the second direction V2.

Next, the method of controlling the image forming system of the embodiment will be described.

The method of controlling the image forming system includes an image forming step, a binding step, and a distribution step. In the image forming step, an image is formed on a sheet S. In the binding step, a plurality of sheets S each having the image formed thereon are bound together to form a sheet bundle. In the distribution step, binding positions of a first sheet bundle and a second sheet bundle are distributed in the first direction V1 or the second direction V2.

In the image forming step, front-surface printing and rear-surface printing are alternately performed. In the binding step, binding positions of the front-surface printed sheets and binding positions related to rear-surface printed sheets are distributed in the first direction V1 or the second direction V2.

The method of controlling the image forming system further includes a supply step for supplying vertically printed sheets and horizontally printed sheets. In the supply step, the vertically printed sheets and the horizontally printed sheets are alternately supplied. In the distribution step, binding positions of the vertical printed sheets and binding positions of the horizontal printed sheets are distributed in the first direction V1 or the second direction V2.

The method of controlling the image forming system further includes an offset step for displacing a sheet S or a sheet bundle which is discharged to the discharge tray 23a or 23b in the first direction V1 or the second direction V2.

The method of controlling the image forming system further includes a mode selection step for selecting either the stacked sheet number priority mode or the stacking state priority mode.

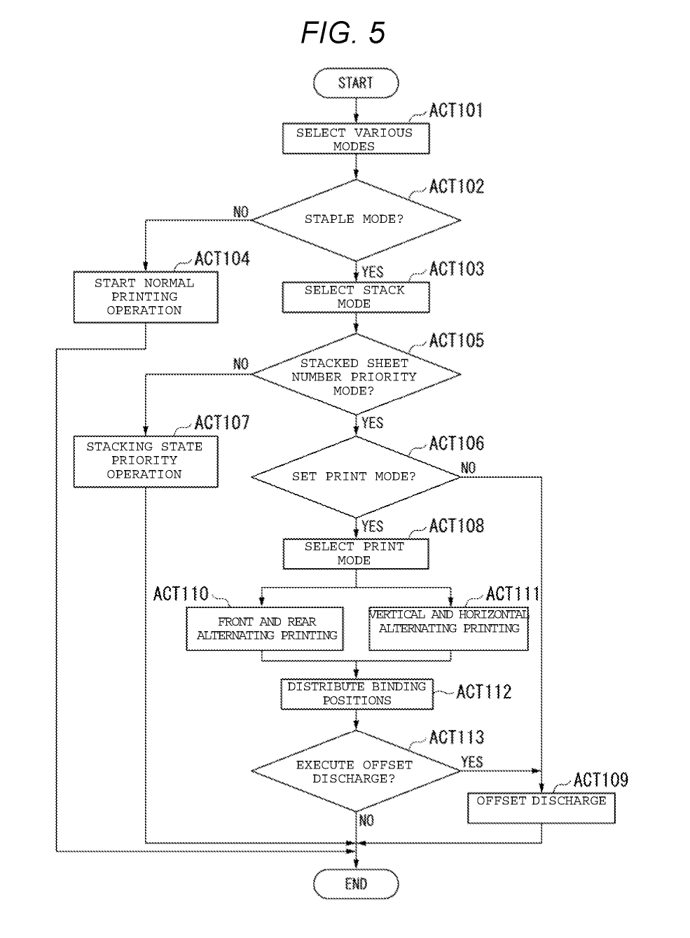

FIG. 5 is a flowchart illustrating an example sequence of operations of controlling the image forming system.

As illustrated in FIG. 5, first, various modes are selected (ACT101). For example, a user selects various modes by pushing various buttons of the mode selection unit 11a in the control panel 11.

Next, the control unit determines whether the “staple mode” is selected (ACT102). For example, the control unit determines whether the button selected by the user is a “staple” button. When the button selected by the user is the “staple” button, the control unit determines that the “staple mode” is selected (ACT102: YES), and advances the process to ACT103. When the button selected by the user is a “sort” button or a “non-sort” button, the control unit determines that the “staple mode” is not selected (ACT102: NO), and advances the process to ACT104.

In ACT104, the control unit starts a normal printing operation. That is, the binding unit 30 does not perform stapling of sheets S. The control unit terminates the process after the execution of the normal printing operation.

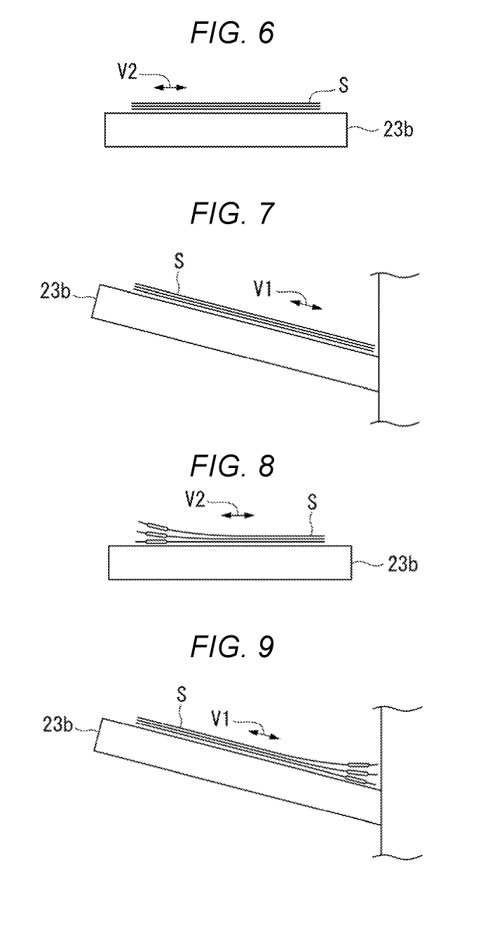

FIG. 6 is a front view illustrating a stacking state of sheets when the normal printing operation is performed. FIG. 6 illustrates a stacking state of sheets S discharged to the discharge tray 23b for the sake of convenience. The stacking state of sheets S discharged to the discharge tray 23a will be omitted in the drawings since it is similar to that in the discharge tray 23b. The omission in the drawing is also found in FIGS. 7 to 10, FIG. 14, FIG. 18, and FIG. 19. In the following drawings, one sheet S and one sheet bundle each will be shown by one line.

As illustrated in FIG. 6, a plurality of sheets S are stacked in order in the discharge tray 23b without being shifted in the second direction V2 when viewed from the front.

FIG. 7 is a side view illustrating a stacking state of sheets when the normal printing operation is performed.

As illustrated in FIG. 7, a plurality of sheets S are stacked in order in the discharge tray 23b without being shifted in the first direction V1 when viewed from the side.

Returning to FIG. 5, in ACT103, the stack mode is selected (mode selection step). For example, the user selects the stack mode by pushing various buttons of the mode selection unit 11a in the control panel 11.

Next, the control unit determines whether the “stacked sheet number priority mode” is selected (ACT105). For example, the control unit determines whether the button selected by the user is a “stacked sheet number priority” button. When the button selected by the user is the “stacked sheet number priority” button, the control unit determines that the “stacked sheet number priority mode” is selected (ACT105: YES), and advances the process to ACT106. When the button selected by the user is a “stacking state priority” button, the control unit determines that the “stacked sheet number priority mode” is not selected (ACT105: NO), and advances the process to ACT107.

In ACT107, the control unit allows a stacking state priority operation to be performed. That is, binding positions of a first sheet bundle S and a second sheet bundle S are in a fixed position without being distributed in the first direction V1 or the second direction V2. The control unit terminates the process after the execution of the stacking state priority operation.

FIG. 8 is a front view illustrating a stacking state of sheet bundles in the stacking state priority mode.

As illustrated in FIG. 8, a plurality of sheet bundles S are stacked in order in the discharge tray 23b without being shifted in the second direction V2 when viewed from the front. However, a part of the sheet bundle in the second direction V2 (that is, a stapled part) protrudes upward.

FIG. 9 is a side view illustrating a stacking state of sheet bundles in the stacking state priority mode.

As illustrated in FIG. 9, sheet bundles are stacked in order in the discharge tray 23b without being shifted in the first direction V1 when viewed from the side. However, a part of the sheet bundle in the first direction V1 (that is, the stapled part of each bundle) protrudes upward.

As described above, a the stapled part of the sheet bundle protrudes upward in the stacking state priority mode. Therefore, when too many sheet bundles are discharged to the discharge tray 23b and stacked, the stacked sheet bundles may collapse.

Returning to FIG. 5, in ACT106, the control unit determines whether to execute “print mode setting”. For example, the control unit determines whether the button selected by the user is a “print mode” button. When the button selected by the user is the “print mode” button, the control unit determines that the “print mode setting” is executed (ACT106: YES), and advances the process to ACT108. When the button selected by the user is an “offset” button, the control unit determines that the “print mode setting” is not executed (ACT106: NO), and advances the process to ACT109.

In ACT109, the control unit executes offset discharge. That is, the control unit controls the offset unit 40 to shift the sheet bundles which are discharged to the discharge tray 23a or 23b in the first direction V1 or the second direction V2 (offset step). A distance in which stapled parts do not overlap each other in the sheet bundle stacking direction is set as an offset quantity. Here, the “sheet bundle stacking direction” means a direction in which sheet bundles are stacked in the discharge tray 23b (that is, a direction of a normal line of an upper surface of the discharge tray 23b).

For example, the control unit controls the offset unit 40 to move the first slider 41 in the second direction V2, thereby displacing the sheet bundles in the second direction V2 (see FIG. 4). Otherwise, the control unit controls the offset unit 40 to move the second slider 42 in the first direction V1, thereby displacing the sheet bundles in the first direction V1 (see FIG. 4). The control unit terminates the process after the execution of the offset discharge.

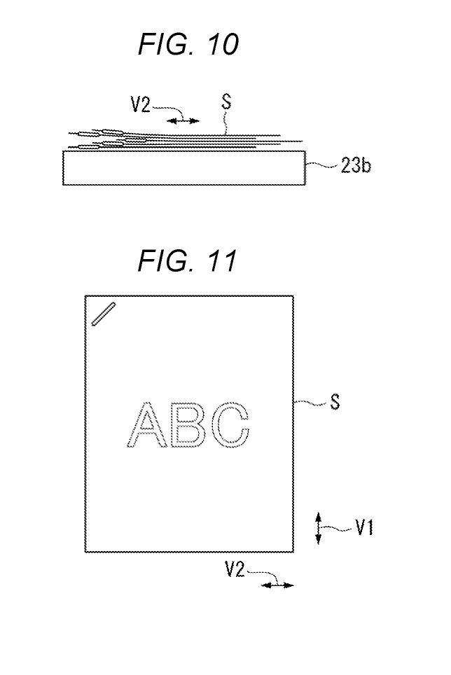

FIG. 10 is a front view illustrating a stacking state of sheet bundles when the offset discharge is performed.

As illustrated in FIG. 10, a plurality of sheet bundles are stacked while being shifted in the second direction V2 in the discharge tray 23b when viewed from the front. That is, binding positions related to the sheet bundles are in a fixed position, but the respective sheet bundles are shifted in the second direction V2. In other words, stapled parts do not overlap each other in the sheet bundle stacking direction.

Returning to FIG. 5, in ACT108, the control unit selects the print mode. For example, the print mode is previously stored in the ROM of the control unit as a control program for operation of the control unit. The ROM stores, as the print mode, either “front and rear alternating printing” or “vertical and horizontal alternating printing”.

When the print mode stored in the ROM is the “front and rear alternating printing”, the control unit executes a print mode of the “front and rear alternating printing” (image forming step, ACT110). That is, the control unit controls the printer unit 13 to alternately perform front-surface printing and rear-surface printing (image forming step). For example, the control unit controls the printer unit 13 to alternately perform a plurality of times of front-surface printing and a plurality of times of rear-surface printing. In the rear-surface printing, nothing is printed on the front surface at the time of simplex printing.

Next, in ACT112, the binding positions are distributed. That is, the control unit controls the binding unit 30 to distribute binding positions related to front-surface printed sheets and binding positions related to rear-surface printed sheets in the second direction V2 (distribution step). Hereinafter, the front-surface printed sheets stapled together will be referred to as “front-surface printed sheet bundle”, and the rear-surface printed sheets stapled together will be referred to as “rear-surface printed sheet bundle”.

FIG. 11 is a plan view of a front-surface printed sheet bundle in the front and rear alternating printing.

As illustrated in FIG. 11, in the distribution step, one corner part (hereinafter, referred to as “first corner part”) of the front-surface printed sheets in the second direction V2 is subjected to stapling. For example, the control unit controls the binding unit 30 to stop the stapler 31 in one third rail portion 32c of the guide rail 32, thereby subjecting the first corner part of the front-surface printed sheets to binding (see FIG. 3). Accordingly, a front-surface printed sheet bundle is obtained.

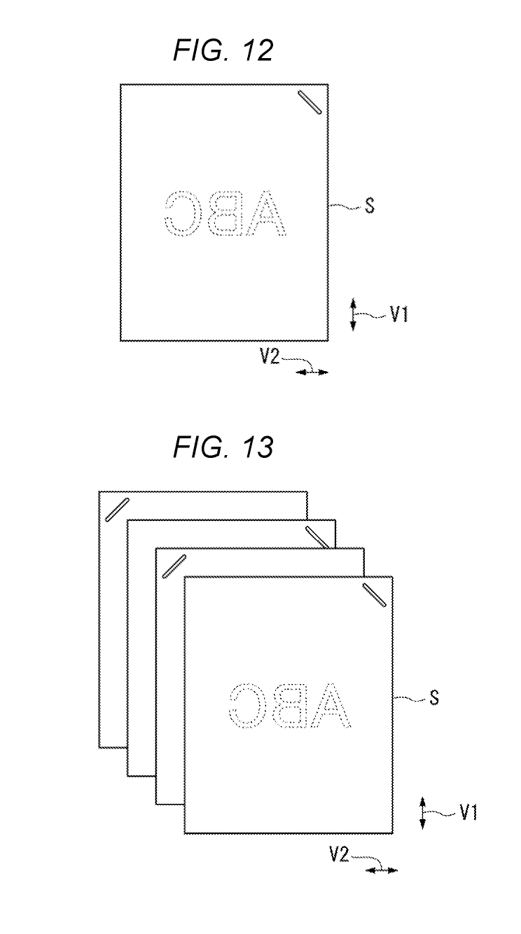

FIG. 12 is a plan view of a rear-surface printed sheet bundle in the front and rear alternating printing.

As illustrated in FIG. 12, in the distribution step, a corner part (hereinafter, referred to as “second corner part”), that is on an opposite side to the first corner part, of the rear-surface printed sheets in the second direction V2 is subjected to stapling. For example, the control unit controls the binding unit 30 to stop the stapler 31 in the other third rail portion 32c of the guide rail 32, thereby subjecting the second corner part of the rear-surface printed sheets to binding (see FIG. 3). Accordingly, a rear-surface printed sheet bundle is obtained.

In this manner, binding positions related to the front-surface printed sheet bundles and binding positions related to the rear-surface printed sheet bundles are distributed in the second direction V2.

FIG. 13 is a diagram illustrating a distribution state of the binding positions when the front and rear alternating printing is performed. In FIG. 13, for the sake of convenience, the respective sheet bundles are shifted in the first direction V1 and the second direction V2 such that the binding positions are shown.

As illustrated in FIG. 13, front-surface printed sheet bundles and rear-surface printed sheet bundles are alternately discharged such that the binding positions in the front-surface printed sheet bundles and the binding positions in the rear-surface printed sheets are distributed in the second direction V2.

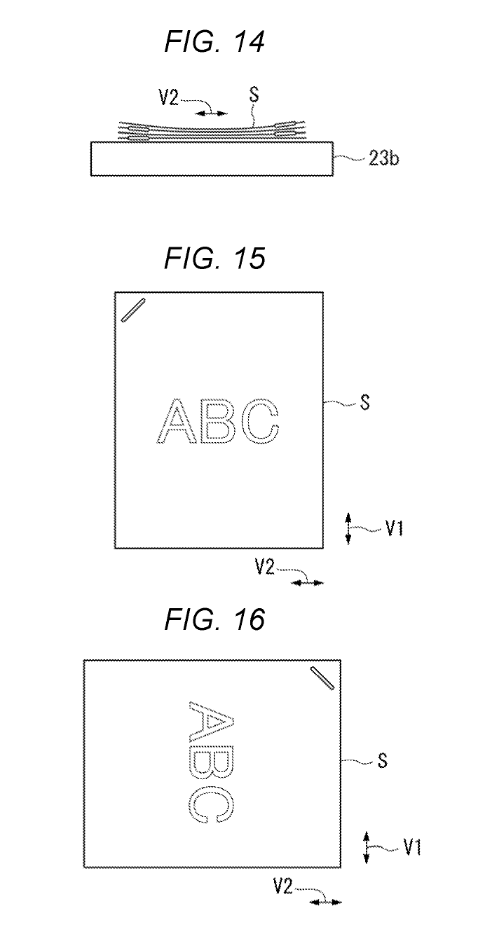

FIG. 14 is a front view illustrating a stacking state of the sheet bundles when the front and rear alternating printing is performed.

As illustrated in FIG. 14, the front-surface printed sheet bundles and the rear-surface printed sheet bundles are alternately stacked in the discharge tray 23b when viewed from the front. That is, the stapled parts are alternately shifted in the second direction V2 in the stacking direction of the sheet bundles. In other words, the stapled parts do not overlap each other continuously in the stacking direction of the sheet bundles.

The binding positions related to the front-surface printed sheet bundles and the binding positions related to the rear-surface printed sheet bundles may be distributed in the first direction V1. For example, in this case, the control unit controls the binding unit 30 to stop the stapler 31 at one end of the first rail portion 32a of the guide rail 32, thereby binding the front-surface printed sheets together (see FIG. 3). In addition, the control unit controls the binding unit 30 to stop the stapler 31 at the other end of the first rail portion 32a of the guide rail 32, thereby binding the rear-surface printed sheets together (see FIG. 3).

Returning to FIG. 5, when the print mode stored in the ROM is the “vertical and horizontal alternating printing”, the control unit executes a print mode of the “vertical and horizontal alternating printing” (image forming step, ACT111). That is, the control unit controls the paper feeding unit 14 to alternately supply vertical printed sheets and horizontal printed sheets (supply step). For example, the control unit controls the paper feeding unit 14 to alternately supply a plurality of vertical printed sheets and a plurality of horizontal printed sheets. The control unit sets vertical sheets having a longer side in the first direction as a type of medium stored in the first medium storage unit in advance. As well, the control unit sets horizontal sheets having a shorter side in the first direction as a type of medium stored in the second medium storage unit in advance.

Next, in ACT 112, the binding positions are distributed. That is, the control unit controls the binding unit 30 to distribute binding positions related to vertical printed sheets and binding positions related to horizontal printed sheets in the second direction V2 (distribution step). Hereinafter, the vertical printed sheets stapled together will be referred to as “vertical printed sheet bundle”, and the horizontal printed sheets stapled together will be referred to as “horizontal printed sheet bundle”.

FIG. 15 is a plan view of a vertical printed sheet bundle in the vertical and horizontal alternating printing.

As illustrated in FIG. 15, in the distribution step, a first corner part of the vertical printed sheets in the second direction V2 is subjected to stapling. For example, the control unit controls the binding unit 30 to stop the stapler 31 in one third rail portion 32c of the guide rail 32, thereby subjecting the first corner part of the vertical printed sheets to binding (see FIG. 3). Accordingly, a vertical printed sheet bundle is obtained.

FIG. 16 is a plan view of a horizontal printed sheet bundle in the vertical and horizontal alternating printing.

As illustrated in FIG. 16, in the distribution step, a second corner part of the horizontal printed sheets in the second direction V2 is subjected to stapling. For example, the control unit controls the binding unit 30 to stop the stapler 31 in the other third rail portion 32c of the guide rail 32, thereby subjecting the second corner part of the horizontal printed sheets to binding (see FIG. 3). Accordingly, a horizontal printed sheet bundle is obtained.

In this manner, binding positions related to the vertical printed sheet bundles and fastening positions related to the horizontal printed sheet bundles are distributed in the second direction V2.

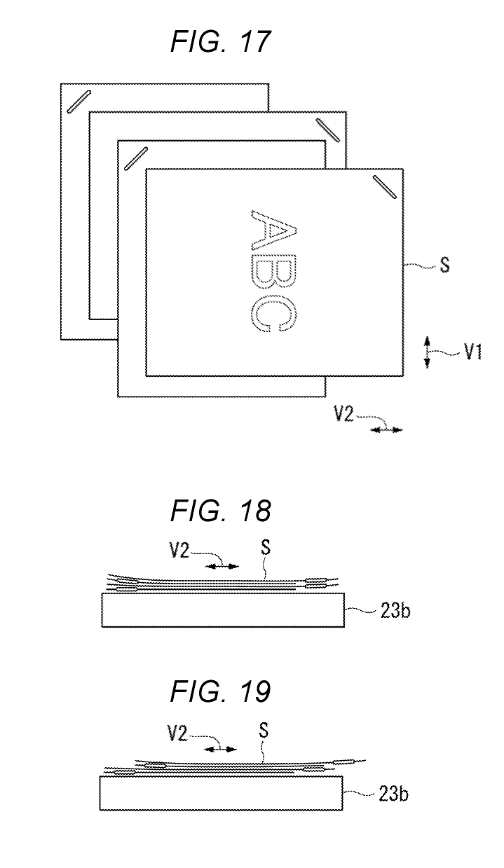

FIG. 17 is a diagram illustrating a distribution state of the binding positions when the vertical and horizontal alternating printing is performed. In FIG. 17, the respective sheet bundles are shifted in the first direction V1 and the second direction V2 such that the binding positions are shown.

As illustrated in FIG. 17, vertical printed sheet bundles and horizontal printed sheet bundles are alternately discharged such that the binding positions in the vertical printed sheet bundles and the binding positions in the horizontal printed sheet bundles are distributed in the second direction V2.

FIG. 18 is a front view illustrating a stacking state of the sheet bundles when the vertical and horizontal alternating printing is performed.

As illustrated in FIG. 18, the vertical printed sheet bundles and the horizontal printed sheet bundles are alternately stacked in the discharge tray 23b when viewed from the front. That is, the stapled parts are alternately shifted in the second direction V2 in the stacking direction of the sheet bundles. In addition, one ends of the vertical printed sheet bundles and the horizontal printed sheet bundles are arranged on one side in the second direction V2. On one side in the second direction V2, the stapled parts do not overlap each other continuously in the stacking direction of the sheet bundles. The other ends of the horizontal printed sheet bundles protrude sideways more than the vertical printed sheet bundles on the other side in the second direction V2. On the other side in the second direction V2, the stapled parts overlap each other continuously in the stacking direction of the sheet bundles.

The binding positions related to the vertical printed sheet bundles and the binding positions related to the horizontal printed sheet bundles may be distributed in the first direction V1. For example, in this case, the control unit controls the binding unit 30 to stop the stapler 31 at one end of the first rail portion 32a of the guide rail 32, thereby binding the vertical printed sheets together (see FIG. 3). In addition, the control unit controls the binding unit 30 to stop the stapler 31 at the other end of the first rail portion 32a of the guide rail 32, thereby binding the horizontal printed sheets together (see FIG. 3).

Returning to FIG. 5, in ACT113, the control unit determines whether the “offset discharge” is executed. For example, the setting of the “offset discharge” is previously stored in the ROM of the control unit as a control program for operation of the control unit. The ROM stores the setting of whether to execute the “offset discharge”.

When the setting of the execution of the “offset discharge” is stored in the ROM (ACT113: YES), the control unit advances the process to ACT109. When the execution of the “offset discharge” is not stored in the ROM (ACT113: NO), the control unit terminates the process.

In ACT109, the control unit executes the “offset discharge”. That is, the control unit shifts the sheet bundles which are discharged to the discharge tray 23a or 23b in the first direction V1 or the second direction V2 (offset step). The control unit terminates the process after the execution of the vertical and horizontal alternating printing and the offset discharge.

FIG. 19 is a front view illustrating a stacking state of the sheet bundles when the vertical and horizontal alternating printing and the offset discharge are executed in combination.

As illustrated in FIG. 19, vertical printed sheet bundles and horizontal printed sheet bundles are alternately stacked in the discharge tray 23b when viewed from the front. In addition, the vertical printed sheet bundles and the horizontal printed sheet bundles are stacked while being shifted in the second direction V2. That is, the stapled parts are alternately shifted in the second direction V2 in the stacking direction of the sheets S. In addition, the stapled parts do not overlap each other in the stacking direction of the sheets S.

The control unit is not limited to the execution of the vertical and horizontal alternating printing and the offset discharge in combination. For example, the control unit may execute the front and rear alternating printing and the offset discharge in combination.

When sheet bundles are continuously discharged to the discharge tray and stacked, stapled parts may protrude. Therefore, the stacked sheet bundles may collapse. Particularly, when a sleep operation is performed to realize power saving, the probability of collapse of the stacked sheet bundles is increased. Therefore, it is necessary to set the full load condition of the sheets in the discharge tray to such a number of sheets that the stacked sheet bundles do not collapse.

The reason for this will be described as follows. The post-processing apparatus includes a detection unit which detects sheet stack information of in the discharge tray. For example, the detection unit includes three sensors (first sensor, second sensor, and third sensor). The first sensor detects the presence or absence of a sheet on the paper discharge tray. The second sensor detects the lower limit position of the paper discharge tray. The third sensor detects the stacking height of the sheets on the paper discharge tray. For example, the third sensor detects a specific location such as a center portion of the paper discharge tray. Otherwise, the third sensor detects the highest position of the stacked sheets using a lever. Based on the detection result of the detection unit, the discharge tray can be lowered to a certain height position. The post-processing apparatus includes a storage unit which stores sheet stack information of the discharge tray. For example, the storage unit is a non-volatile memory such as an EEPROM. The storage unit has a smaller number of times of rewriting and a smaller memory capacity than a storage device such as a HDD in a MFP. In general, when a sleep operation is performed (during standby of MFP), the power source of the post-processing apparatus is turned off for low power consumption. During the period of time in which the power source of the post-processing apparatus is turned off, the sheet stack information is not clear since it is not detected. In addition, after the power source of the post-processing apparatus after the sleep operation is turned on, (hereinafter, referred to as “after sleep restoration”), the sheet stack information of the discharge tray becomes known. Therefore, the detection unit determines the full load in a state in which there is no information about the sheets stacked in the discharge tray. As a result, even when the discharge tray has a loading capacity, it is necessary to quickly determine that the tray is fully loaded when there are sheets thereon, or it is necessary to set the full load condition to a minimum number of sheets after the sleep restoration. That is, it is necessary to set the full load condition of the sheets in the discharge tray to such a number of sheets that the stacked sheet bundles do not collapse.

In order to avoid this, the post-processing apparatus may be provided with a HDD which is similar to that of an MFP or a memory backed up by a battery. However, an expensive storage device is provided depending only on the determination of full load after the sleep restoration. The system may be notified of the stack information of the post-processing apparatus, and may store and manage the sheet stack information of the discharge tray even during the sleep operation. However, the system should always continuously manage the stack information of the post processing apparatus that is unrelated to the operation of the system.

According to the embodiment, the image forming system 1 includes the printer unit 13, the binding unit 30, and the control unit. The printer unit 13 forms an image on a sheet S. The binding unit 30 staples the sheets S each having the image formed thereon together. The control unit controls the printer unit 13 and the binding unit 30 such that binding positions related to a first sheet S and a second sheet S are distributed in the first direction V1 or the second direction V2. By virtue of the configuration, the following effects are achieved. By distributing the binding positions related to the first sheet S and the second sheet S in the first direction V1 or the second direction V2, the sheet bundles are continuously discharged to the discharge tray 23a or 23b, and it is possible to suppress protrusion of the stapled parts even when the sheet bundles are stacked. Accordingly, collapse of the stacked sheet bundles can be suppressed. In addition, power saving associated with the sleep operation of the MFP can be realized. In addition, since it is not necessary to provide an expensive storage device in the post-processing apparatus, the cost can be reduced. In addition, it is also not necessary for the system to manage the stack information of the post-processing apparatus.

The control unit controls the printer unit 13 such that the front-surface printing and the rear-surface printing are alternately performed. In addition, the control unit controls the binding unit 30 such that binding positions related to front-surface printed sheets and binding positions related to rear-surface printed sheets are distributed in the second direction V2. By virtue of the configuration, the following effects are achieved. Stapled parts are alternately shifted in the first direction V1 or the second direction V2 in the stacking direction of the sheet bundles. Therefore, it is possible to avoid continuous overlap of the stapled parts in the stacking direction of the sheet bundles in the front-surface printed sheet bundles and the rear-surface printed sheet bundles. Accordingly, it is possible to more securely suppress collapse of the stacked sheet bundles.

The control unit controls the paper feeding unit 14 such that vertical printed sheets and horizontal printed sheets are alternately supplied. In addition, the control unit controls the binding unit 30 such that binding positions related to vertical printed sheets and binding positions related to horizontal printed sheets are distributed in the first direction V1 or the second direction V2. By virtue of the configuration, the following effects are achieved. In the stacking direction of the sheet bundles, stapled parts are alternately shifted in the first direction V1 or the second direction V2. Therefore, it is possible to partially avoid continuous overlap of the stapled parts in the stacking direction of the sheet bundles in the vertical printed sheet bundles and the horizontal printed sheet bundles. Accordingly, it is possible to more securely suppress collapse of the stacked sheet bundles.

The following effects are achieved when the image forming system 1 is further provided with the offset unit 40 which shifts sheets S which are discharged to the discharge tray 23a or 23b in the first direction V1 or the second direction V2. Since the respective sheet bundles are shifted in the first direction V1 or the second direction V2, it is possible to avoid overlap of the stapled parts in the stacking direction of the sheet bundles in the sheet bundles. Accordingly, it is possible to simply suppress collapse of the sheet bundles. In addition, when the vertical and horizontal alternating printing and the offset discharge are executed in combination, it is more securely suppress collapse of the sheet bundles along with the effect of distributing the binding positions by the vertical and horizontal alternating printing. When the front and rear alternating printing and the offset discharge are executed in combination, it is also more securely suppress collapse of the sheet bundles along with the effect of distributing the binding positions by the front and rear alternating printing. Particularly, the above-described execution in combination is actually advantageous when the thickness of the stapled part is smaller than the thickness of the sheet part in the sheet bundles.

The following effects are achieved when the image forming system 1 is further provided with the mode selection unit 11a allowing a user to select the stacked sheet number priority mode and the stacking state priority mode. The stack mode of the discharge tray 23a or 23b can be selected according to a user's request.

The method of controlling the image forming system includes the image forming step, the binding step, and the distribution step. In the image forming step, an image is formed on a sheet S. In the binding step, the sheets S each having an image formed thereon are bound together. In the distribution step, binding positions related to a first sheet S and a second sheet S are distributed in the first direction V1 or the second direction V2. By virtue of the steps, the following effects are achieved. By distributing the binding positions related to the first sheet S and the second sheet S in the first direction V1 or the second direction V2, the sheet bundles are continuously discharged to the discharge tray 23a or 23b, and it is possible to suppress protrusion of the stapled parts even when the sheet bundles are stacked. Accordingly, collapse of the stacked sheet bundles can be suppressed. In addition, power saving associated with the sleep operation of the MFP can be realized. In addition, since it is not necessary to provide an expensive storage device in the post-processing apparatus, the cost can be reduced. In addition, it is also not necessary for the system to manage the stack information of the post-processing apparatus.

In the image forming step, the front-surface printing and the rear-surface printing are alternately performed. In the binding step, binding positions related to front-surface printed sheets and binding positions related to rear-surface printed sheets are distributed in the first direction V1 or the second direction V2. By virtue of the steps, the following effects are achieved. In the stacking direction of the sheet bundles, the stapled parts are alternately shifted in the first direction V1 or the second direction V2. Therefore, it is possible to avoid continuous overlap of the stapled parts in the stacking direction of the sheet bundles in the front-surface printed sheet bundles and the rear-surface printed sheet bundles. Accordingly, it is possible to more securely suppress collapse of the stacked sheet bundles.

The method of controlling the image forming system further includes the supply step for supplying vertical printed sheets and horizontal printed sheets. In the supply step, the vertical printed sheets and the horizontal printed sheets are alternately supplied. In the distribution step, binding positions related to the vertical printed sheets and binding positions related to the horizontal printed sheets are distributed in the first direction V1 or the second direction V2. By virtue of the steps, the following effects are achieved. In the stacking direction of the sheet bundles, the stapled parts are alternately shifted in the first direction V1 or the second direction V2. Therefore, it is possible to partially avoid continuous overlap of the stapled parts in the stacking direction of the sheet bundles in the vertical printed sheet bundles and the horizontal printed sheet bundles. Accordingly, it is possible to more securely suppress collapse of the stacked sheet bundles.

The following effects are achieved when the method of controlling the image forming system further includes the offset step for displacing sheets S which are discharged to the discharge tray 23a or 23b in the first direction V1 or the second direction V2. Since the respective sheet bundles are shifted in the first direction V1 or the second direction V2, it is possible to avoid overlap of the stapled parts in the stacking direction of the sheet bundles in the sheet bundles. Accordingly, it is possible to simply suppress collapse of the sheet bundles. In addition, when the vertical and horizontal alternating printing and the offset discharge are executed in combination, it is more securely suppress collapse of the sheet bundles along with the effect of distributing the binding positions by the vertical and horizontal alternating printing. When the front and rear alternating printing and the offset discharge are executed in combination, it is also more securely suppress collapse of the sheet bundles along with the effect of distributing the binding positions by the front and rear alternating printing. Particularly, the above-described execution in combination is actually advantageous when the thickness of the stapled part is smaller than the thickness of the sheet part in the sheet bundles.

The following effects are achieved when the method of controlling the image forming system further includes the mode selection step for selecting either the stacked sheet number priority mode or the stacking state priority mode. The stack mode of the discharge tray 23a or 23b can be selected according to a user's request.

Hereinafter, modifications of the embodiment will be described.

The invention is not limited to the configuration in which the processing unit 22 includes the offset unit 40. For example, the discharge unit 23 may be provided with the offset unit 40.

The invention is not limited to the configuration in which the binding unit 30 performs binding with a needle. For example, the binding unit 30 may perform binding with paper (so-called needle-free stapling).

The invention is not limited to the configuration in which the control unit controls the printer unit 13 such that the front-surface printing and the rear-surface printing are alternately performed. For example, the post-processing apparatus 3 may be provided with a reversing device capable of reversing the front and rear surfaces of a sheet S.

The invention is not limited to the configuration in which the control unit controls the distribution of the binding positions by making the image forming apparatus 2 and the post-processing apparatus 3 cooperate. For example, the post-processing apparatus 3 may independently control the distribution of the binding positions. For example, the post-processing apparatus 3 may be provided with a CPU which is similar to that of the image forming apparatus 2 or a HDD.

According to at least one embodiment described above, the image forming system 1 includes the printer unit 13, the binding unit 30, and the control unit. The printer unit 13 forms an image on a sheet S. The binding unit 30 staples the sheets S each having the image formed thereon together. The control unit controls the printer unit 13 and the binding unit 30 such that binding positions related to a first sheet S and a second sheet S are distributed in the first direction V1 or the second direction V2. By virtue of the configuration, the following effects are achieved. By distributing the binding positions related to the first sheet S and the second sheet S in the first direction V1 or the second direction V2, the sheet bundles are continuously discharged to the discharge tray 23a or 23b, and it is possible to suppress protrusion of the stapled parts even when the sheet bundles are stacked. Accordingly, collapse of the stacked sheet bundles can be suppressed.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and there equivalents are intended to cover such forms or modifications as would fall within the scope and spirit of the invention.

What is claimed is:

1. An image forming system comprising:
an image forming unit configured to form an image on each of a plurality of recording media;
a binding unit configured to bind at least two of the recording media together at a binding position thereof to form a bundle;
a discharge tray configured to hold bundles formed by the binding unit; and
a control unit configured to control the binding unit and the image forming unit so that a first bundle and a subsequent second bundle are stacked on the discharge tray with the respective binding positions thereof in a first direction parallel to a transport direction of the recording media and a second direction perpendicular to the transport direction of the recording media.

2. The system according to claim 1, wherein the control unit is further configured to:
control the image forming unit to perform a front-surface printing for forming an image on a first surface of the recording media of the first bundle and a rear-surface printing for forming an image on a second surface of the recording media of the second bundle on an opposite side to the first surface, and
control the binding unit to bind the media so that the binding position of the first bundle and the binding position of the second bundle are distributed between the first direction and the second direction.

3. The system according to claim 1, further comprising:
a first recording medium storage unit configured to supply recording media to the image forming unit with a longer edge thereof parallel to the transport direction;
a second recording medium storage unit configured to supply recording media to the image forming unit with a longer edge thereof perpendicular to the transport direction; and
wherein the control unit is further configured to:
control the first recording medium storage unit and the second recording medium storage unit to alternately supply recording media for the first and second bundles, respectively, to the image forming unit, and
control to the binding unit to bind the recording media so that the first bundle is formed with recording media supplied from the first recording medium storage unit and the second bundle is formed with recording media supplied from the second recording medium storage unit.

4. The system according to claim 1, further comprising:
an offset unit configured to shift a bundle which is discharged to the discharge tray in the first direction or the second direction.

5. The system according to claim 4, wherein the offset unit shifts the second bundle a first distance and shifts a third bundle subsequent to the second bundle a second distance greater than the first distance.

6. The system according to claim 1, further comprising:
a mode selection unit configured to receive a selection of one of a first mode in which the binding positions of the first bundle and the second bundle are distributed between the first direction and the second direction, and a second mode in which the binding positions of the first bundle and the second bundle are in a fixed position without being distributed between the first direction and the second direction.

7. The system according to claim 6, further comprising:
an offset unit configured to shift a bundle which is discharged to a discharge tray in the first direction or the second direction,
wherein the control unit is further configured to
control the offset unit to not shift the first bundle and the second bundle if the mode selection unit receives a selection of the first mode, and
control the offset unit to shift the second bundle in the first direction or the second direction if the mode selection unit receives a selection of the second mode.

8. An sheet processing method comprising the steps of:
conveying a plurality of recording media from an image forming unit to a post-processing unit;
in the post processing unit, binding at least two of the recording media conveyed from the image forming section at a binding position thereof to form a first bundle;
in the post processing unit, binding at least two of the recording media conveyed from the image forming section at a binding position thereof to form a second bundle;
discharging the first bundle and the second bundle from the post processing unit to a discharge tray so that the first bundle and a subsequent second bundle are stacked on the discharge tray with the respective binding positions thereof in a first direction parallel to a transport direction of the recording media and a second direction perpendicular to the transport direction of the recording media.

9. The method according to claim 8, further comprising the step of:
controlling the image forming unit to perform a front-surface printing for forming an image on a first surface of the recording media of the first bundle and a rear-surface printing for forming an image on a second surface of the recording media of the second bundle on an opposite side to the first surface, wherein
the post-processing unit binds the recording media so that the binding position of the first bundle and the binding position of the second bundle are distributed between the first direction and the second direction.

10. The method according to claim 8, wherein
the recording media for forming the first bundle are conveyed to the post-processing unit with a longer edge parallel to the transport direction, and
the recording media for forming the second bundle are conveyed to the post processing unit with a longer edge perpendicular to the transport direction.

11. The method according to claim 8, further comprising:
shifting at least one of the first bundle and the second bundle which is discharged to the discharge tray in the first direction or the second direction.

12. The method according to claim 11, wherein
the second bundle is shifted a first distance, and
a third bundle subsequent to the second bundle is shifted a second distance greater than the first distance.

13. The method according to claim 8, further comprising the step of:
receiving a selection of one of a first mode in which the binding positions of the first bundle and the second bundle are distributed between the first direction and the second direction, and a second mode in which the binding positions of the first bundle and the second bundle are in a fixed position without being distributed between the first direction and the second direction.

14. A post-processing apparatus comprising:
a conveying unit configured to convey each of a plurality of recording media received from an image forming apparatus;
a binding unit configured to bind at least two of the recording media together at a binding position thereof to form a bundle;
a discharge tray configured to hold bundles formed by the binding unit; and
a control unit configured to control the binding unit and the image forming unit so that a first bundle and a subsequent second bundle are stacked on the discharge tray with the respective binding positions thereof in a first direction parallel to a transport direction of the recording media and a second direction perpendicular to the transport direction of the recording media.

15. The apparatus according to claim 14, wherein
the recording media received from the image forming unit are arranged so that an image is formed on a first surface of the recording media of the first bundle and an image is formed on a second surface of the recording media of the second bundle on an opposite side to the first surface, and
the binding unit binds the recording media so that the binding position of the first bundle and the binding position of the second bundle are distributed between the first direction and the second direction.

16. The apparatus according to claim 14, wherein:
the binding unit to bind the recording media so that the first bundle has a longer edge thereof parallel to the transport direction, and the second bundle has a longer edge thereof perpendicular to the transport direction.

17. The apparatus according to claim 14, further comprising:
an offset unit configured to shift a bundle which is discharged to the discharge tray in the first direction or the second direction.

18. The apparatus according to claim 14, wherein the offset unit shifts the second bundle a first distance and shifts a third bundle subsequent to the second bundle a second distance greater than the first distance.

19. The apparatus according to claim 14, further comprising:
a mode selection unit configured to receive a selection of one of a first mode in which the binding positions of the first bundle and the second bundle are distributed between the first direction and the second direction, and a second mode in which the binding positions of the first bundle and the second bundle are in a fixed position without being distributed between the first direction and the second direction.

20. The apparatus according to claim 19, further comprising:
an offset unit configured to shift a bundle which is discharged to a discharge tray in the first direction or the second direction,
wherein the control unit is further configured to
control the offset unit to not shift the first bundle and the second bundle if the mode selection unit receives a selection of the first mode, and
control the offset unit to shift the second bundle in the first direction or the second direction if the mode selection unit receives a selection of the second mode.
